(19) United States
(12) Patent Application Publication
(10) Pub. No.: US 2003/0091912 A1
(43) Pub. Date: May 15, 2003

(54) Reversible thermosensible recording medium and information recording and displaying card using the same

(76) Inventors: Hideaki Ueda, Kishiwada-Shi (JP); Yoshihisa Terasaka, Suita-Shi (JP); Mitsutoshi Nakamura, Kawanishi-Shi (JP); Yasumitsu Fujino, Itami-Shi (JP); Tatsuhiko Miyoshi, Toyokawa-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/290,134

(22) Filed: Nov. 7, 2002

(30) Foreign Application Priority Data
Nov. 8, 2001 (JP) 2001-343874

(51) Int. Cl. B41M 5/28

(52) U.S. Cl. 430/19; 430/20; 503/218

(57) ABSTRACT

Disclosed is a reversible thermosensible recording medium comprising a base board, a rewritable thermosensible recording layer which contains a liquid crystal compound showing a cholesteric liquid crystal phase and is provided on the base board, and a protective layer which is provided on the recording layer and contains an ultraviolet curing resin and at least one of a lubricant and an ultraviolet stabilizer.

### CROSS-REFERENCE TO RELATED APPLICATIONS

This application is based on Japanese Patent Application No. 2001-343874 filed in Japan on Nov. 8, 2001, the entire content of which is hereby incorporated by reference.

### BACKGROUND OF THE INVENTION

1. Field of the Invention

The present invention relates to a reversible thermosensible recording medium which is capable of rewriting display, an information recording and displaying card having the recording medium, and an information recording and displaying system using the card.

2. Description of the Related Art

In recent years, under condition where an interest in resources conservation and recycling becomes high, it is desired that a recording medium such as paper can be used repeatedly. As for the investigation of such a technique, an attention is paid to rewritable recording and displaying materials where recording and deleting are possible by simple means with energy conservation. Such a kind of a reversible recording and displaying material can be used for recycling a recording medium and also making information in an IC card, a magnetic card, an optical card or the like and another information visible, thus making various applications possible.

Conventionally, as a reversible thermosensible recording medium, a leuco dye/developing tone reducing agent, organic low-molecular/high-molecular matrix, and a high-molecular cholesteric liquid crystal are known. However, these recording materials prevents full-color display and requires a lot of time for finishing display.

Taking into consideration such a problem, the inventors of this application have suggested-a rewritable information recording and displaying card having a visible information displaying section which mainly contains a cholesteric liquid crystal compound with higher isotropic phase change temperature than its melting point, and an information recording and displaying system using the card in Japanese Unexamined Patent Publication No. 2000-90229. The recording medium is provided with a rewritable thermosensible recording layer mainly containing a cholesteric liquid crystal compound on a base board and provided with a protective layer thereon.

However, in this recording medium, since a thermal head slides on the protective layer at the time of recording and the recording medium is allowed to pass between heat rollers or a hot stamp is pressurized, the protective layer is easily worn out and thus displayed characters or the like are blurred, thereby arising a problem that durability is deteriorated. Moreover, a countermeasure against deterioration in the liquid crystal compound due to ultraviolet rays is required.

### SUMMARY OF THE INVENTION

Therefore, an object of the present invention is to provide a reversible thermosensible recording medium with good durability where abrasion resistance of a protective layer is improved, an information recording and displaying card having the recording medium and an information recording and displaying system using the card.

Another object of the invention is to provide a reversible thermosensible recording medium which is capable of preventing deterioration in a liquid crystal compound due to ultraviolet rays, an information recording and displaying card having the recording medium and an information recording and displaying system using the card.

In order to achieve the above object, a reversible thermosensible recording medium according to a first aspect of the present invention includes: a base board; a rewritable thermosensible recording layer which contains a liquid crystal compound showing a cholesteric liquid crystal phase and is provided on the base board; and a protective layer which is provided on the recording layer and contains an ultraviolet curing resin and a lubricant.

Images such as characters, numerals and graphics are written onto the reversible thermosensible recording medium of the first aspect by heating using a thermal head, a light energy emitted from a laser beam scanning apparatus or an energy of a flash light exposed via a mask, or heating from a hot stamp. Moreover, display information is deleted by entire heating using a hot stamp or a heat roller, entire exposure using a light energy.

In the reversible thermosensible recording medium according to the first aspect, it is preferable that the protective layer mainly contains ultraviolet curing resin. In this case, the protective layer can be easily formed on the thermosensible recording layer. Moreover, it is preferable that ultraviolet curing resin contains a lubricant, and in this case, the surface becomes smooth and abrasion resistance is improved. Therefore, durability against a thermal head, a heat roller or a hot stamp is satisfactory, and displayed characters have no blur.

A reversible thermosensible recording medium according to a second aspect of the present invention includes: a base board; a rewritable thermosensible recording layer which contains a liquid crystal compound showing a cholesteric liquid crystal phase and is provided on the base board; and a protective layer which is provided on the recording layer and contains an ultraviolet curing resin and an ultraviolet stabilizer. The protective layer may contain a lubricant.

In the reversible thermosensible recording medium according to the second aspect, it is preferable that the protective layer mainly contains ultraviolet curing resin. In this case, the protective layer can be easily formed on the thermosensible recording layer. Moreover, it is preferable that ultraviolet curing resin contains an ultraviolet stabilizer, and in this case, the liquid crystal compound can be protected from being deteriorated due to emission of ultraviolet rays. Moreover, a deterioration in the protective layer, a defect in display can be prevented effectively.

In any reversible thermosensible recording medium, it is preferable that a molecular weight of the cholesteric liquid crystal compound is 1000 to 2000 and glass transition temperature is not less than 50° C. A medium molecular cholesteric liquid crystal compound with a molecular weight of about 1000 to 2000 enables desired colors to be displayed at high speed by controlling a heating temperature, and thus making full-color display possible. Moreover, display can be deleted by re-heating. When a molecular weight is smaller than 1000, memory properties are deteriorated, and when a molecular weight is larger than 2000, responsibility to writing is deteriorated, and a transition temperature to a cholesteric liquid crystal phase becomes too high. Moreover, when the glass transition temperature is not less than 50° C., a change in display color at normal temperature and a change in display color due to user's temperature can be avoided.

Typical examples of the medium molecular cholesteric liquid crystal compound can be the following compounds represented by chemical formulas (A) through (G):

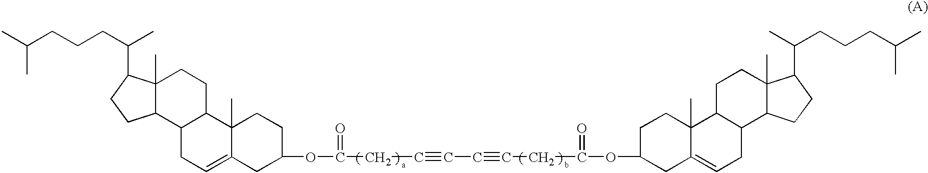

a and b represent combinations of integers where a+B=5 to 20.

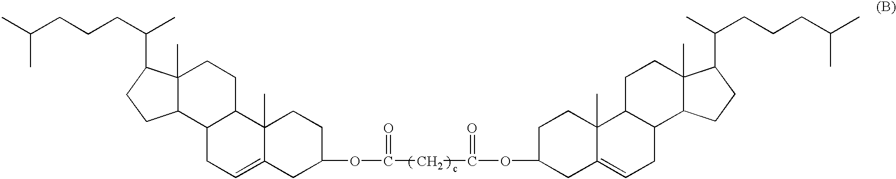

c represents integers 5 to 20.

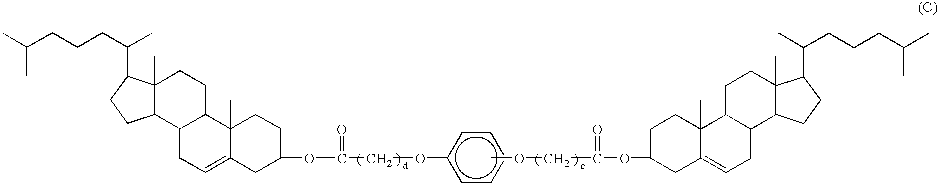

d and e represent combinations of integers where d+e=5 to 20.

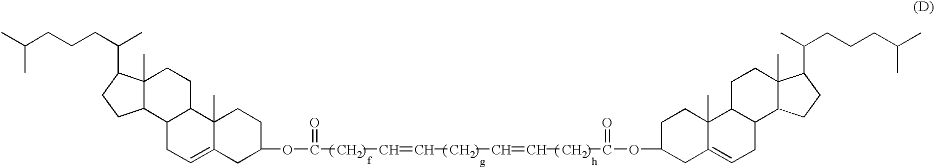

f, g and h represent combinations of integers 5 to 20.

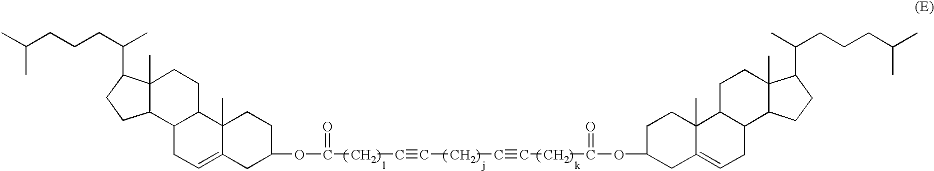

i, j and k represent combinations of integers where i+j+k=5 to 20.

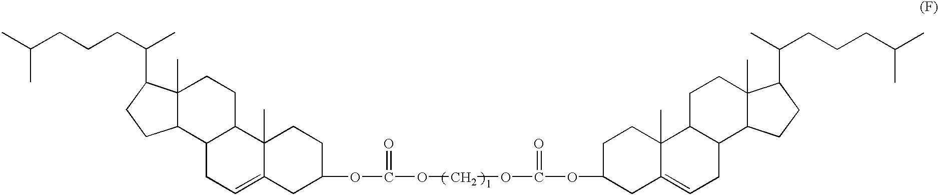

l represents integers 5 to 20.

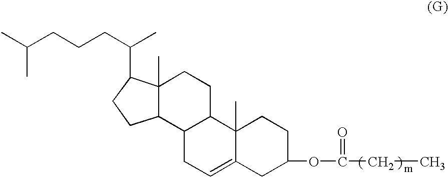

m represents integers 5 to 20.

These compounds may be used individually or plural kinds of them may be combined, or they may be combined with another cholesteric liquid crystal compounds. Particularly, plural kinds of medium molecular cholesteric liquid crystal compounds are combined, so that there are such advantages that a speed of display is heightened, display colors are multiple and have no mottling, a color changing temperature range is wide, and temperature control is easy. Moreover, besides the exemplified compounds, various cholesteric liquid crystal compounds having cholesterol group can be used.

Further, the thermosensible recording layer may be formed by a composite film of the above-mentioned medium molecular cholesteric liquid crystal compound and a high molecular resin. With such a composite film, the mechanical strength of the recording layer can be heightened, the medium becomes strong against bending and friction. Further, the recording layer may include a spacer with constant shape. As a result, the thickness of the recording layer can be uniform, and in the case where display is deleted by a heat roller, the thickness of the recording layer can be maintained constant. As a spacer, for example, spherical or a plate-shaped resin fine particles or inorganic fine particles which are in the market for a liquid crystal panel can be used.

The protective layer externally protects the recording layer mechanically and chemically, and it is preferable that an acrylate resin is used as an ultraviolet curing resin. The acrylate resin easily contains a lubricant, and it is applied to the recording layer to be hardened, so that the protective layer can be formed easily even when its area is comparatively large.

A lubricant is contained in ultraviolet curing resin in a ratio of 0.1 to 50% by weight, for example. Examples of lubricant which can be used are inorganic compound fine particles such as silicon oxide, titanium oxide, zirconium oxide, aluminum hydroxide, calcium carbonate, zinc oxide, barium sulfate, silica gel, active kaolin, clay, kaolin, diatomite, zirconium compound and glass fine particles, and hybrid fine particles such as organosilica, organotitania and alumina sol, and resin fine particles such as polyvinylidene fluoride, polyethylene, polypropylene, polystyrene.

In addition, liquid-type co-lubricant such as silicone oil, modified silicone oil, silane coupling material, molybdenum disulfide, titanium coupling material may be combined for the lubricant. Further, wax such as zinc stearate, amide stearate, amide palmitate, amide laurate, ethylene-bis-stearylamide, methylene-bis-stearylamide, methylol stearylamide, polyethylene wax, paraffin wax and carnauba wax, and higher fatty acid derivatives such as higher alcohol, higher fatty acid and higher fatty ester also function as the co-lubricant effectively.

These liquid-type or molecular co-lubricants are combined, thereby showing leveling effect. As a result, abrasion, peeling and damage of the protective layer due to friction with a thermal head, a hot stamp and a heat roller can be prevented effectively. An adding amount of co-lubricant to the main lubricant can be adjusted in a wide range where a ratio of the lubricant to the co-lubricant is 100:1 to 1:1. As a content of the main lubricant becomes smaller, sliding property of a thermal head or the like becomes worse, thereby requiring a certain amount thereof.

Ultraviolet stabilizer is contained in ultraviolet curing resin in the ratio of 0.1 to 30% by weight. As an ultraviolet stabilizer which can be used, benzotriazole derivative, salicylic acid derivative, 2-hyddroxybenzophenone derivative, benzoic acid derivative, cinnamic acid derivative, coumarin derivative or the like can be used. These ultraviolet stabilizers in the market may be used.

The lubricant and the ultraviolet stabilizer are individually added to a resin component of the protective layer in the ratio of 0.1 to 30% by weight. When an adding amount is small, the effect cannot be showed efficiently, and when too large, the strength of the protective layer becomes weak, thereby arising a problem such that the protective layer is easily abraded. Moreover, it is preferable that a total amount when the lubricant is combined with the ultraviolet stabilizer is adjusted within a range of 1 to 40% by weight with respect to a resin component of the protective layer.

An information recording and displaying card according to a third aspect of the present invention includes: a card-shaped base board; an invisible information recording section which is provided on the base board and on which invisible information is recorded; and a visible information displaying section which is provided on the base board and on which visible information is recorded and displayed. The visible information recording section includes a rewritable thermosensible recording layer which is provided on the base board and contains a liquid crystal component showing a cholesteric liquid crystal phase, and a protective layer which is provided on the recording layer and contains ultraviolet curing resin, and the protective layer includes at least one of lubricant and ultraviolet stabilizer. In this information recording and displaying card, required information is displayed rewritably by using the reversible thermosensible recording section, and for example, non-visible information in the card can be displayed as visible information.

An information recording and displaying system according to a fourth aspect of the present invention is an information recording and displaying system using the information recording and displaying card depending on the third aspect, and it has a reader section for reading invisible information recorded in the invisible information recording section of the card, and a writer section for updating display contents of the visible information and displaying section of the card. In this information recording and displaying system, the reversible thermosensible recording medium is used as the visible information displaying section so that required information can be displayed rewritably. For example, non-visible information in the card can be displayed as visible information.

In the information recording and displaying card according to the third aspect of the present invention and the information recording and displaying system according to the fourth aspect, for example, in the case of a bank card, payment, sum in account and the like are rewritten to be displayed every time of use, and in the case of a prepaid card, used amount and remain are rewritten to be displayed every time of use, so that a user can obtain such information visually.

In addition, the reversible thermosensible recording medium can display information with color without requiring built-in electric current, a driving electrode, polarizing plate or the like, and has a simple structure. Therefore, it can be manufactured at a low rate.

Further, as mentioned above, since the reversible thermosensible recording medium according to the first or the second aspects of the present invention can withstand long-time use, display content is rewritten repeatedly. Moreover, the reversible thermosensible recording medium is useful particularly for the information recording and displaying card according to the third aspect and the information recording and displaying system according to the fourth aspect which are used in various environment indoors and outdoors.

### BRIEF DESCRIPTION OF THE DRAWINGS

These and other objects, advantages and features of the present invention will become apparent from the following description thereof taken in conjunction with the accompanying drawings, in which:

FIG. 1 is a cross-sectional view showing a reversible thermosensible recording medium according to a first embodiment of the present invention;

FIG. 2 is a schematic structural diagram showing one example of a thermal printer;

FIG. 3 is a schematic structural diagram showing another example of a thermal printer;

FIG. 4 is a plan view showing a thermal head installed into the thermal printer;

FIG. 5 is a schematic perspective view showing one example of a laser printer;

FIGS. 6(A) and 6(B) show an information recording and displaying card according to a second embodiment of the present invention, FIG. 6(A) is a surface view and FIG. 6(B) is a rear surface diagram;

FIG. 7 is a cross-sectional view showing one portion of the information recording and displaying card shown in FIGS. 6(A) and 6(B);

FIGS. 8(A) and 8(B) show the information recording and displaying card according to a third embodiment of the present invention, FIG. 8(A) is a surface diagram and FIG. 8(B) is a rear surface diagram;

FIG. 9 is a cross-sectional diagram showing one portion of the information recording and displaying card shown in FIGS. 8(A) and 8(B); and

FIG. 10 is an entire structural diagram showing the information recording and displaying system according to a fourth embodiment of the present invention.

### DETAILED DESCRIPTION OF THE PREFERRED EMBODIMENTS

There will be explained concretely a reversible thermosensible recording medium, an information recording and displaying card and an information recording and displaying system according to embodiments of the present invention with reference to attached drawings. Here, in the following embodiments and experimental examples, an explanation is given with examples of concrete names of substances, but they are only examples and the invention is not limited to use of these materials, thereby making it possible to use various materials for the recording medium, the card and the system of the present invention.

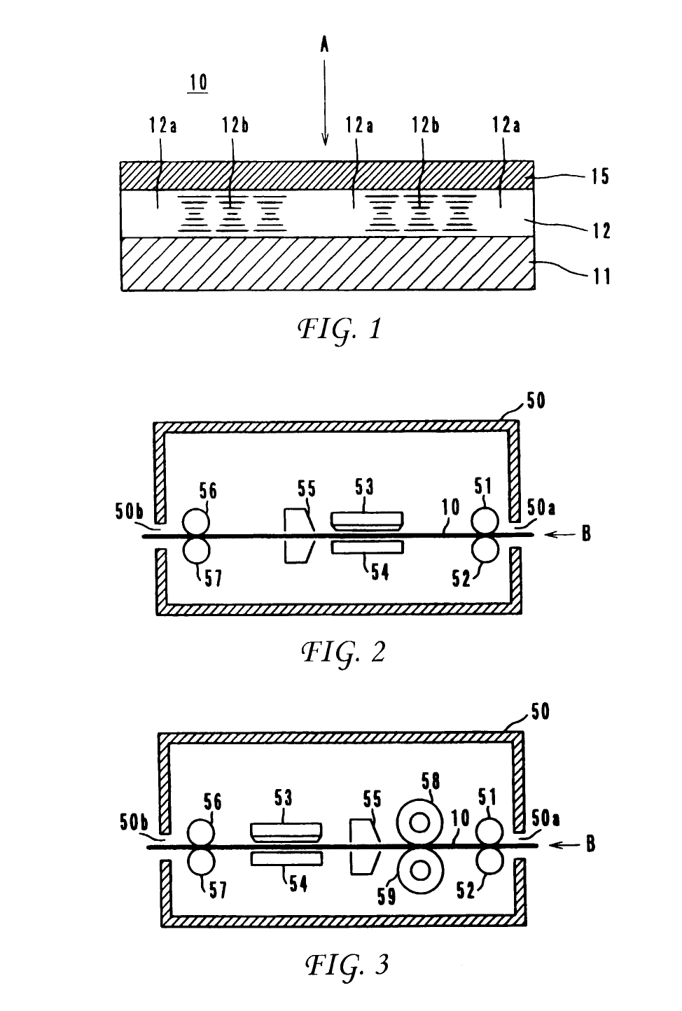

(First Embodiment, Reversible Thermosensible Recording Medium, see FIG. 1)

As shown in FIG. 1, a reversible thermosensible recording medium 10 is provided with a reversible thermosensible recording layer 12 on a surface of a base board 11, and with a protective layer 15 thereon.

Various plastic materials can be used for the base board 11 and for example, black PET (polyethylene terephthalate) can be used. A transparent base board or a base board colored with white or the like may be used, and in this case, a black light absorbing layer is formed on a front or rear surface of the base board 11.

The thermosensible recording layer 12 is a liquid crystal layer mainly containing a simple substance or a compound of a medium molecular cholesteric liquid crystal compound showing a cholesteric liquid crystal phase, and a concretely liquid crystal compound will be mentioned later.

The protective layer 15 is formed in such a manner that a solution obtained by dispersing a lubricant and/or ultraviolet stabilizer into ultraviolet curing resin is applied onto the thermosensible recording layer 12 and irradiated with ultraviolet rays to be hardened.

When the reversible thermosensible recording layer 12 is heated to be higher than an isotropic phase change temperature and then cooled, the liquid crystal compound shows cholesteric liquid crystal phase directing a helical axis vertically to the base board 11 to reflect a light of a specified wavelength according to temperature.

For example, a cholesteric liquid crystal compound, mentioned later, which is mixed with a compound represented by chemical structural formulas (A1) and (B1) shows red at about 85° C., green at about 100° C. and blue about 120° C., and then is abruptly cooled from these temperatures to be solidified in the reflected state. Moreover, the cholesteric liquid crystal compound is heated to not less than about 130° C. and then is abruptly cooled to be transparent. Namely, When the compound is heated to not less than 130° C. by heat roller or the like and then is abruptly cooled, the entire surface of the thermosensible recording layer 12 becomes transparent. Moreover, also when the compound is maintained at about 80° C. as a glass transition temperature for a predetermined time and then is cooled gradually to room temperature, the thermosensible recording layer 12 becomes transparent. At this time, when the base board 11 is black or the base board 11 is provided with a light absorbing layer on its front or rear surface, the thermosensible recording layer 12 is observed as black.

When the thermosensible recording layer 12 is partially heated and abruptly cooled by conventionally-known thermal head, the heated portion shows a reflected color according to cooled temperature. Namely, a display color of liquid crystal is observed on the black background. In FIG. 1, a reference numeral 12a indicates a transparent portion, and a reference numeral 12b indicates a portion which still remains as cholesteric liquid crystal phase. Therefore, when writing is performed at 100° C. by the thermal head, green display can be observed viewed from a direction of an arrow A. Moreover, when writing is selectively performed at 85° C., 100° C. and 120° C., full-color display is possible. In a portion where display with low reflectance is desired, a black display portion is mixed therewith, so that the reflectance can be lowered.

To delete display of the thermosensible recording layer 12, the liquid crystal may be heated to not less than melting point by contact with the heat roller or emission of a ray. The liquid crystal is abruptly cooled from this state to be transparent and is cooled gradually to be milky.

In addition, an image can be written by digital exposure using a laser beam scanning apparatus, flash exposure via a mask or a hot stamp as well as a thermal head.

(Thermal Printer, see FIGS. 2 to 4)

FIG. 2 shows one example of a thermal printer for writing information to the thermosensible recording layer 12. This printer is provided with carrying rollers 51 and 52, a thermal head 53, a platen 54, a cooler 55, carrying rollers 56 and 57 inside a housing 50 along an advancing direction B of the recording medium 10.

The recording medium 10 enters the printer from an inlet 50a, and is carried between the platen 54 and the thermal head 53 by the carrying rollers 51 and 52, so that information is written here. After the heating by use of the thermal head 53 is stopped, the recording medium 10 is cooled abruptly and naturally, so that writing is fixed. Thereafter, the recording medium 10 is discharged from an outlet 50b by the carrying rollers 56 and 57.

After the thermosensible recording layer 12 of the recording medium 10 passes through respective heating elements provided on the thermal head 53, it is cooled abruptly and naturally, so that cooling means for the recording medium 12 is originally unnecessary. However, for a more accurate display operation, the cooler 55 is provided.

As sown in FIG. 4, the thermal head 53 is provided with four heating elements 53r, 53g, 53b and 53e which are arranged in parallel with each other in a direction of an arrow C intersecting perpendicularly to the advancing direction B of the recording medium 10. The heating element 53r is used for writing with red, the heating element 53g for green and the heating element 53b for blue. The heating element 53e is used for deleting an image. The respective heating elements have a lot of pixel components arranged along the advancing direction B.

The thermal head 53 is constituted so as to reciprocate to the direction C intersecting perpendicularly to the feeding direction B of the recording medium 10 in synchronization with advance of the recording medium 10. The heating elements move to the direction C and simultaneously turned on/off based on image information for respective colors, and heating and non-heating are repeated, thereby writing an image by a number of lines equal to that of pixels onto the recording layer 12. In such a manner, one color image is finally reproduced on the recording layer 12. Preferably, the writing by using of the heating elements is performed on the deletion-use heating element 53e, the blue-use heating element 53b, the green-use heating element 53g and the red-use heating element 53r in this order, that is, the order of higher temperature. Here, one heating element can be used for three colors and deletion, but it is desirable to perform writing for each of three colors because temperature control is complicated.

In addition, deletion of written display is performed in such a manner that the thermal printer is used similarly to heat the recording layer 12 to not less than melting point by means of the deletion-use heating element 53e and cool it abruptly, thereby making the recording layer 12 transparent to delete the display. The deletion may be executed on its whole surface or a portion.

Here, the recording layer 12 is kept at a temperature around the glass transition temperature for a predetermined time and cooled gradually, thereby deleting display.

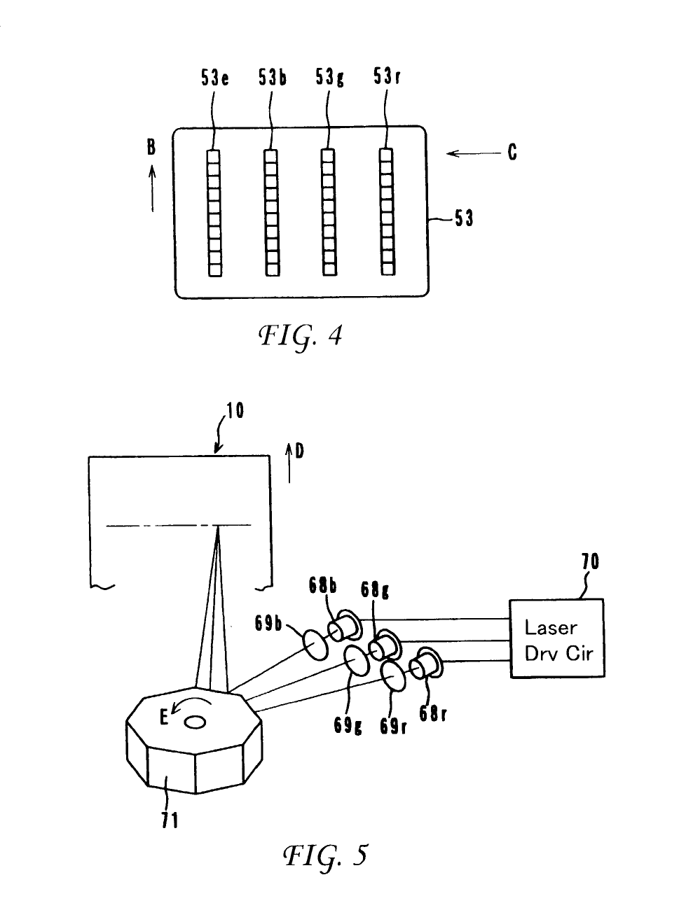

FIG. 3 shows another example of the thermal printer for writing information onto the thermosensible recording layer 12. This printer is provided with carrying rollers 51 and 52, heat rollers 58 and 59, a cooler 55, a thermal head 53, a platen 54, and carrying rollers 56 and 57 inside the housing 50 along an advancing direction B of the recording medium 10.

The recording medium 10 enters the printer from an inlet 50a and is carried from the carrying rollers 51 and 52 to the heat rollers 58 and 59 to be heated to not less than melting point and further cooled by the cooler 55 abruptly. Initialization is performed there, and written information, if any, is deleted. Next, the recording medium 10 is carried between the platen 54 and the thermal head 53, and information is written here. The recording medium 10 is cooled abruptly and naturally after heating at the thermal head 53 is stopped, thereby fixing the writing. Thereafter, the recording medium 10 is discharged from the outlet 50b by the carrying rollers 56 and 57.

In the thermal printer shown in FIG. 3, information of the recording medium 12 is previously deleted by the heat rollers 58 and 59 at the step before the thermal head 53. Therefore, the thermal head 53 is composed of the heating elements 53b, 53g and 53r, and the heating element 53e shown in FIG. 4 is omitted.

Here, after the thermosensible recording layer 12 of the recording medium 10 passes through the respective heating elements provided at the thermal head 53, it is abruptly cooled naturally. Therefore, cooling means for the recording layer 12 is not required originally, but one more cooler may be provided in order to perform a display operation more securely.

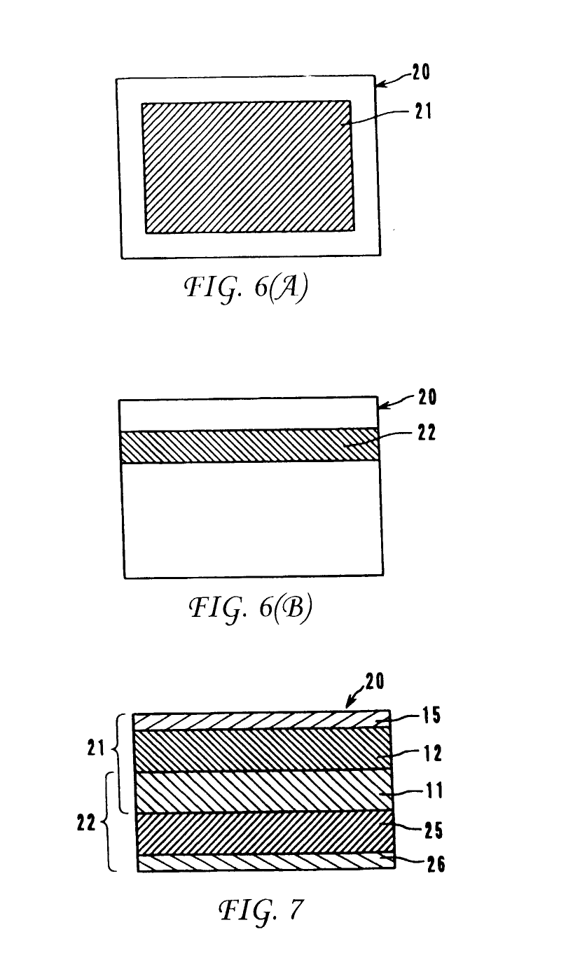

(Laser Printer, see FIG. 5)

information can be recorded onto the recording medium 10 also by using a laser printer shown in FIG. 5. In this case, in order to convert an energy of a laser beam into a heat, it is desirable that a light/heat conversion layer is provided to the recording medium 10. The light/heat conversion layer is obtained by adding an absorbent for absorbing a laser beam or an infrared ray absorbent. Moreover, a material with infrared ray absorbing property may be used for the base board 11.

In this laser printer, lasers 68b, 68g and 68r such as semiconductor laser, carbon dioxide laser and YAG laser for writing with blue, green and red are modulated by a drive circuit 70, and laser beams emitted from them enter a polygon mirror 71 via collimating lenses 69b, 69g and 69r. The polygon mirror 71 is rotated to a direction of an arrow E and thus the laser beams are deflected based on the rotation to scan the recording medium 10 linearly. The recording medium 10 is carried to a direction of an arrow D, thereby writing two-dimensional color information to the recording layer 12. Not shown in FIG. 5, needless to say an optical element such as fθ lens is also provided to the laser printer.

A writing color is adjusted by controlling a radiant energy of a laser. Therefore, writing can be performed also by controlling energies of the laser beams for respective colors by means of one laser. However, energies can be controlled easily when writing is performed according to respective colors by using three lasers. Moreover, similarly to the thermal printer described before, a laser for display deletion may be provided.

(Second Embodiment, Information Recording and Displaying Card, see FIGS. 6(A), 6(B) and 7)

An information recording and displaying card 20 is, as shown in FIGS. 6(A) and 6(B), provided with a visible information displaying section 21 on its front surface and with an invisible information recording section 22 on its rear surface. Sectional structures of the displaying section 21 and the recording section 22 are shown in FIG. 7. That is, the displaying section 21 is provided with a thermosensible recording layer 12 on a front surface of a base board 11 and the recording layer 12 is coated with a protective layer 15 similarly to the reversible thermosensible recording medium 10. The recording section 22 is provided with a recording layer 25 on the rear surface of the base board 11, and the recording layer 25 is coated with the protective layer 26. For example, a magnetic recording material such as ferrite powder or a magneto-optical recording material is used for the recording layer 25.

The invisible information recording section 22 can be constituted so as to have arbitrary shape such as quadrate and arbitrary size besides a stripe shape shown in FIG. 6(B), and its entire rear surface may be used as an invisible information recording section. In addition, a transparent base board is used, so that the invisible information recording section serves also as a light absorbing layer.

(Third Embodiment, Information Recording and Displaying Card, see FIGS. 8(A), 6(B) and 9)

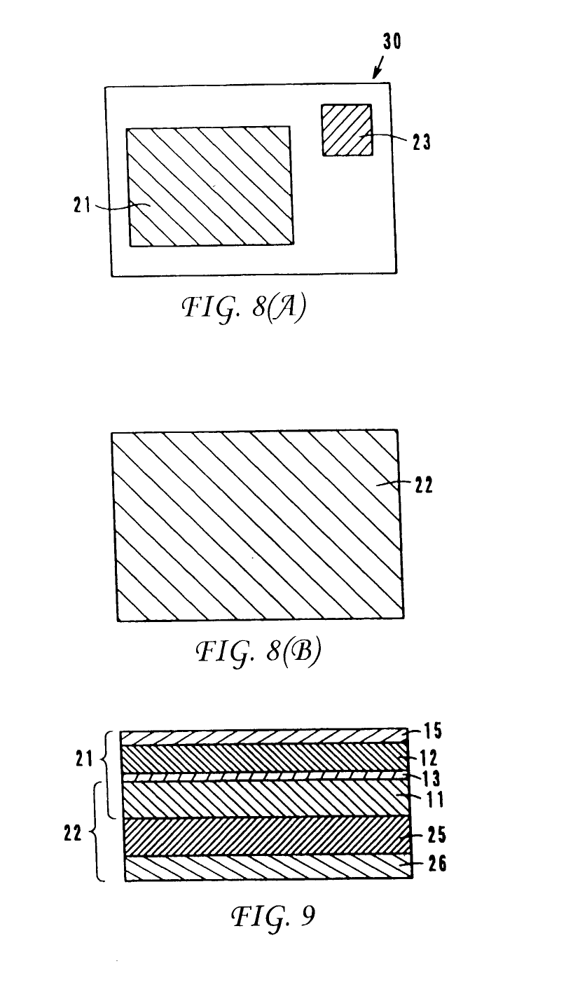

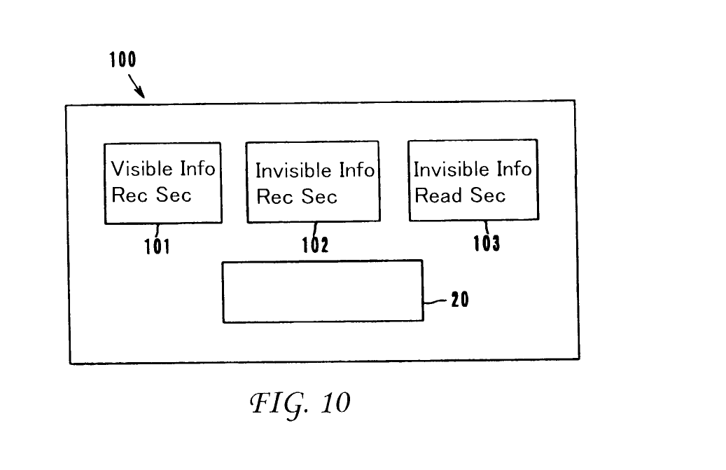

An information recording and displaying card 30 is, as shown in FIGS. 8(A) and 6(B), provided with a visible information displaying section 21 and an IC section 23 on the front surface of the card 30, and is provided with an invisible information recording section 22 on its rear surface. Sectional structures of the displaying section 21 and the recording medium 22 are as shown in FIG. 9. Namely, the displaying section 21 is provided with a thermosensible recording layer 12 on the front surface of the base board 11, mentioned above, via a light absorbing layer 13, and the thermosensible recording layer 12 is coated with a protective layer 15. The recording section 22 is provided with the recording layer 25 on the rear surface of the base board 11, and the recording layer 25 is coated with a protective layer 26.

The IC section 23 is used as a memory for recording information and may have such a structure that it is driven externally by a contact system, or a structure having a coil or the like for generating induction electromotive force in a non-contact system.

(Fourth Embodiment, Information Recording and Displaying System, see FIG. 10)

An information recording and displaying system 100 is for recording and displaying information on the information recording and displaying card 20, and includes a visible information recording section 101 for performing recording/deletion on the visible information displaying section 21 and an invisible information recording section 102 for recording/deletion on the invisible information recording section 22, and further has an invisible information reading section 103 for reading information recorded on the invisible information recording section 22 if necessary.

Since a cholesteric liquid crystal compound is used for the visible information displaying section 21, a thermal printer shown in FIG. 2 or 3 or a laser printer shown in FIG. 6 is used as the visible information recording section 101. A part of the information in the invisible information recording section 22 and information which is convenient to be visible are displayed on the visible information displaying section 21 with colors, and is deleted or re-displayed as the need arises.

A card reader/writer which is specially designed or in the market is used as the invisible information recording section 102 and the invisible information reading section 103 to record, delete/read information on the invisible information recording section 22. If the invisible information recording section 22 is a magnetic recording layer, for example, recording is read by a reader/writer using a magnetic head, and new recording is performed and deletion is possible. The reader/writer may have a function which is capable of inputting information to itself and may be controlled by input information from an external apparatus such as a computer.

### DESCRIPTION OF EXPERIMENTAL EXAMPLES

Next, there will be explained below details of the reversible thermosensible recording medium and the information recording and displaying card of the present invention exemplifying the experimental examples 1 to 10. Not here that, for comparison, also comparative examples 1 and 2 are explained.

### Experimental Example 1

A black polyethylene naphthalate film with a thickness of 500 μm was used as a base board and liquid crystal compounds represented by the following chemical formulas (A1) and (B1) were mixed in a weight ratio of 1:2. An obtained mixture was heated to be fused to 170° C. and it was applied to the base board into a thickness of 10 μm, so that a thermosensible recording layer was obtained.

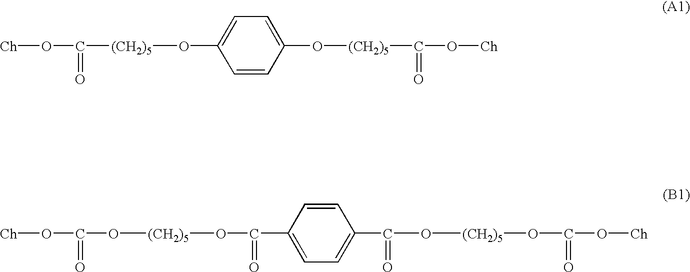

In both (A1) and (B1), Ch is

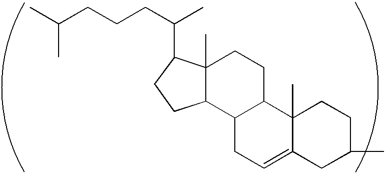

Next, 95 parts by weight of 75% butyl acetate solution (made by Dainippon Ink and Chemicals, Inc.: UNIDIC C7-157) of urethane acrylate ultraviolet curing resin, 4 parts by weight of calcium carbonate with particle diameter of 0.03 μm, and 0.5 parts by weigh of silicone oil (made by Shin-Etsu Silicones: KF96) were dispersed by ultrasonic wave so that a solution was prepared. The solution was applied by a wire bar onto the thermosensible recording layer so that its film thickness after drying becomes 2 μm, and was irradiated with ultraviolet rays and dried at 60° C. for 24 hours to be hardened. In such a manner, a protective layer was formed.

The entire reversible thermosensible recording medium was heated at 80° C. for 10 seconds and cooled gradually, thereby obtaining a black background. Next, after the whole recording medium was cooled to room temperature and printing was executed by a reader/writer SD500-GPIII made by SANDENSHI KOGYO K.K., blue characters without blur were recorded. Moreover, the entire recording medium was again heated at 80° C. for 10 seconds and cooled gradually, thereby deleting the recorded characters. Even when recording and deletion were repeated, a trace which indicates recording history did not remain.

### Experimental Example 2

A transparent polyethersulphone film with a thickness of 300 μm was used as a base board. Carbon black was dispersed into silicone resin (Toshiba Silicone Co., Ltd.: YR3370) and a catalyst (Toshiba Silicone Co., Ltd.: CR15) was mixed therewith, so that an isopropyl alcohol solution was obtained. This solution was applied to the front surface of the base board into a thickness of 5 μm and was thermoset at 130° C., thereby forming a black light absorbing layer. Thereafter, the thermosensible recording layer similar to the experimental example 1 was formed on the light absorbing layer.

Next, 95 parts by weight of 75% butyl acetate solution (made by Dainippon Ink and Chemicals, Inc.: UNIDIC C7-157) of urethane acrylate ultraviolet curing resin, 4 parts by weight of silica powder with particle diameter of 0.1 Aim, and 0.5 parts by weigh of polyethylene wax were dispersed by ultrasonic wave so that a solution was prepared. The solution was applied by a wire bar onto the thermosensible recording layer so that its film thickness after drying becomes 1 μm, and was irradiated with ultraviolet rays and dried at 60° C. for 24 hours to be hardened. In such a manner, a protective layer was formed.

The entire reversible thermosensible recording medium was heated at 80° C. for 10 seconds, thereby obtaining a black background. Next, after the whole recording medium was cooled to room temperature and printing was executed by a reader/writer SD500-GPIII, blue characters without blur were recorded. Moreover, the entire recording medium was again heated at 80° C. for 10 seconds, thereby deleting the recorded characters. Even when recording and deletion were repeated, a trace which indicates recording history did not remain.

### Experimental Example 3

A black polyethersulphone film with a thickness of 500 μm was used as a base board and liquid crystal compounds represented by the following chemical formulas (C1) and (D1) were mixed in a weight ratio of 1:1. An obtained mixture was heated to be fused to 140° C. and it was applied to the base board into a thickness of 10 μm, so that a thermosensible recording layer was obtained.

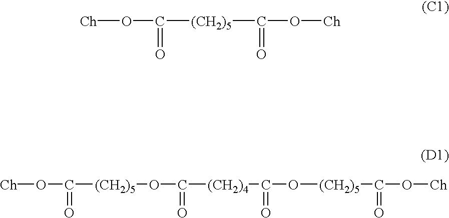

In both (C1) and (D1), Ch is

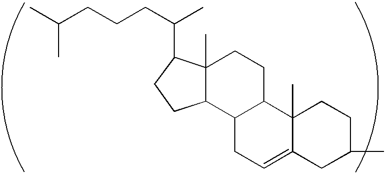

Next, 95 parts by weight of 75% butyl acetate solution (made by Dainippon Ink and Chemicals, Inc.: UNIDIC C7-157) of urethane acrylate ultraviolet curing resin, 5 parts by weight of titanium oxide with particle diameter of 0.5 μm, and 0.5 parts by weight of silicone oil (made by Shin-Etsu Silicones: KF96) were dispersed by ultrasonic wave so that a solution was prepared. The solution was applied by a wire bar onto the thermosensible recording layer so that its film thickness after drying becomes 2 μm, and was irradiated with ultraviolet rays and dried at 60° C. for 24 hours to be hardened. In such a manner, a protective layer was formed.

The entire reversible thermosensible recording medium was temporarily heated to 140° C. and cooled to 80° C. and further cooled abruptly to room temperature, thereby obtaining a green background. Next, printing was executed by a reader/writer SD500-GPIII, black characters without blur were recorded. Moreover, the entire recording medium was again heated to 140° C. and cooled to 80° C. and further cooled abruptly to room temperature, thereby deleting the recorded characters. Even when recording and deletion were repeated, a trace which indicates recording history did not remain.

### Experimental Example 4

A black polyethylene terephthalate film with a thickness of 500 μm was used as a base board, and a compound represented by the following chemical formula (E1) was heated to 140° C. to be fused. The fused compound was applied onto the base board into a thickness of 10 μm, so that a thermosensible recording layer was obtained.

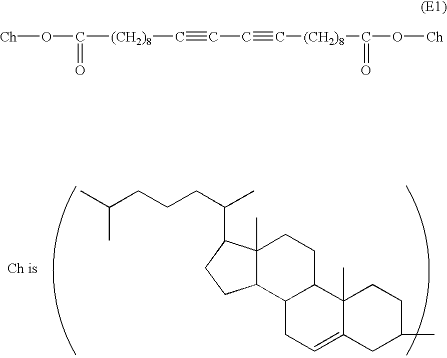

Next, 95 parts by weight of an acrylate ultraviolet curing resin (made by JSR: Z7010-V22), 4 parts by weight of zinc oxide with particle diameter of 0.3 μm, 0.3 part by weight of zinc stearate, 0.2 part by weight of silicone oil (made by Shin-Etsu Silicones: KF96) were dispersed by ultrasonic wave, so that a solution was prepared. The solution was applied by a wire bar onto the thermosensible recording layer so that its film thickness after drying becomes 3 μm and was irradiated with ultraviolet rays and was dried at 60° C. for 24 hours to be hardened. In such a manner, a protective layer was formed.

The entire reversible thermosensible recording medium was temporarily heated to 130° C. and cooled to 95° C. and further cooled abruptly to room temperature, thereby obtaining a green background. Next, printing was executed by a reader/writer SD500-GPIII, black characters without blur were recorded. Moreover, the entire recording medium was again heated to 130° C. and cooled to 95° C. and further cooled abruptly to room temperature, thereby deleting the recorded characters. Even when recording and deletion were repeated, a trace which indicates recording history did not remain.

### Experimental Example 5

A white polyethylene naphthalate film with a thickness of 500 μm was used as a base board. Carbon black was dispersed into silicone resin (made by Toshiba Silicone Co., Ltd.: YR3370) and a catalyst (Toshiba Silicone Co., Ltd.: CR15) was mixed therewith, so that an isopropyl alcohol solution was obtained. This solution was applied to the front surface of the base board into a thickness of 5 μm and was thermoset at 130° C., thereby forming a black light absorbing layer.

Thereafter, 10 parts by weight of liquid crystal compounds represented by the above chemical formulas (A1) and (B1), 5 parts by weight of polyester resin (made by Toyobo Co., Ltd.: VYLON 200), and 0.1 part by weight of silica-made spacer with a diameter of 10 μm were mixed with 100 parts by weight of tetrahydrofuran to be fused. An obtained solution was applied to the light absorbing layer by a blade and heated to be dried, so that a thermosensible recording layer with a thickness of 10 μm was obtained.

Next, 100 parts by weight of acrylate ultraviolet curing resin (made by JSR: Z7010-V22) mixed with silica and talc was dispersed by ultrasonic wave, so that a solution was prepared, and the solution was applied to the thermosensible recording layer by a wire bar so that its film thickness after drying becomes 3 μm. Ultraviolet rays was emitted thereto, and the recording layer was dried at 60° C. for 24 hours to be hardened, so that a protective layer was formed.

The entire reversible thermosensible recording medium was heated at 80° C. for 10 seconds, thereby obtaining a black background. Next, after the whole recording medium was cooled to room temperature and printing was executed by a reader/writer SD500-GPIII, blue characters without blur were recorded. Moreover, the entire recording medium was again heated at 80° C. for 10 seconds, thereby deleting the recorded characters. Even when recording and deletion were repeated, a trace which indicates recording history did not remain.

### Experimental Example 6

A white polyethersulphone film with a thickness of 500 μm was used as a base board. Carbon black was dispersed into silicone resin (made by Toshiba Silicone Co., Ltd.: YR3370) and a catalyst (Toshiba Silicone Co., Ltd.: CR15) was mixed therewith, so that an isopropyl alcohol solution was obtained. This solution was applied to the front surface of the base board into a thickness of 5 μm and was thermoset at 130° C., thereby forming a black light absorbing layer.

Thereafter, each 10 parts by weight of liquid crystal compounds represented by the above chemical formulas (C1) and (D1), 5 parts by weight of polyester resin (made by Toyobo Co., Ltd.: VYLON 200), and 0.1 part by weight of silica-made spacer with a diameter of 10 μm were mixed with 100 parts by weight of tetrahydrofuran so as to be fused. An obtained solution was applied to the light absorbing layer by a blade and heated to be dried, so that a thermosensible recording layer with a thickness of 10 μm was obtained.

Next, 95 parts by weight of epoxy acrylate ultraviolet curing resin (made by Toagosei Co., Ltd.: ARONIXTEP SUV3700), 18 parts by weight of polymerization initiator (made by Ciba-Geigy: DAROCUR), 4 parts by weight of zinc oxide with particle diameter of 0.05 am, and 0.5 part by weight of silicone oil (Shin-Etsu Silicones: KF96) were dispersed to 200 parts by weight of methyl ethyl ketone by ultrasonic wave, so that a solution was prepared, and the solution was applied to the thermosensible recording layer by a wire bar so that its film thickness after drying becomes 2 μm. Ultraviolet rays was emitted thereto, and the recording layer was dried at 60° C. for 24 hours to be hardened, so that a protective layer was formed.

The entire reversible thermosensible recording medium was temporarily heated to 140° C. and cooled to 80° C. and further cooled abruptly to room temperature, thereby obtaining a green background. Next, printing was executed by a reader/writer SD500-GPIII, black characters without blur were recorded. Moreover, the entire recording medium was again heated to 140° C. and cooled to 80° C. and further cooled abruptly to room temperature, thereby deleting the recorded characters. Even when recording and deletion were repeated, a trace which indicates recording history did not remain.

### Experimental Example 7

A black polyethersulphone film with a thickness of 500 μm was used as a base board. 10 parts by weight of Y—Fe₂O₃, 10 parts by weight of vinyl chloride-vinyl acetate-vinyl alcohol copolymer (made by UCC: VAGH), and 2 parts by weight of isocyanate (made by Nippon Polyurethane Industry Co., Ltd.: CORONATE L) were dispersed to a mixed solution of 40 parts by weight of methyl ethyl ketone and 40 parts by weight of toluene. The solution was applied by a wire bar to the base board and was dried, so that a magnetic recording layer with thickness of about 10 μm was formed as an invisible information recording section. A protective layer of the magnetic recording layer was formed by a urethane acrylate ultraviolet curing resin (made by Dainippon Ink and Chemicals, Inc.: UNIDIC C7-157) into a thickness of 2 μm.

Each 3 parts by weigh of liquid crystal compounds represented by the chemical formulas (C1) and (D1) were mixed with 40 parts by weight of tetrahydrofuran to be fused. An obtained solution was applied by a blade to an opposite surface of the baseboard and was heated and dried so that a thermosensible recording layer with a thickness of 8 μm was formed as a visible information displaying section.

Next, 100 parts by weight of silicon acrylate ultraviolet curing resin (made by Toshiba Silicone Co. Ltd.: UVHC-1101), and 5 parts by weight of fluoroplastic lubricant (Nippon Oil and Fats Co., Ltd.: MODIPER FS710) were dispersed to 100 parts by weight of isopropyl alcohol by ultrasonic wave. A solvent was prepared in such a manner and was applied by a wire bar to the thermosensible recording layer so that its film thickness after drying becomes 3 μm. The recording layer was irradiated with ultraviolet rays to be hardened, so that a protective layer was formed.

The entire reversible thermosensible recording medium was temporarily heated to 140° C. and cooled to 80° C. and further cooled abruptly to room temperature, thereby obtaining a green background. Next, printing was executed by a reader/writer SD500-GPIII, black characters without blur were recorded. Moreover, the entire recording medium was again heated to 140° C. and cooled to 80° C. and further cooled abruptly to room temperature, thereby deleting the recorded characters. Even when recording and deletion were repeated, a trace which indicates recording history did not remain.

### Comparative Example 1

A black polyethylene naphthalate film with a thickness of 500 μm was used as a base board and liquid crystal compounds represented by the above chemical formulas (A1) and (B1) were mixed in a weight ratio of 1:2. An obtained mixture was heated to be fused to 170° C. and it was applied to the base board into a thickness of 10 μm, so that a thermosensible recording layer was obtained.

Next, 100 parts by weight of 75% butyl acetate solution (made by Dainippon Ink and Chemicals, Inc.: UNIDIC C7-157) of urethane acrylate ultraviolet curing resin, was dispersed by ultrasonic wave so that a solution was prepared. The solution was applied by a wire bar onto the thermosensible recording layer so that its film thickness after drying becomes 2 μm, and is irradiated with ultraviolet rays and dried at 60° C. for 24 hours to be hardened. In such a manner, a protective layer was formed.

The entire reversible thermosensible recording medium was heated at 80° C. for 10 seconds and cooled gradually, thereby obtaining a black background. Next, after the whole recording medium was cooled to room temperature and printing was executed by a reader/writer SD500-GPIII, blue characters without blur were recorded. Moreover, the entire recording medium was again heated at 80° C. for 10 seconds and cooled gradually, thereby deleting the recorded characters. However, a trace which is seemed to be caused by a contact with writer remained.

### Comparative Example 2

A black polyethylene naphthalate film with a thickness of 500 μm was used as a base board and liquid crystal compounds represented by the above chemical formulas (A1) and (B1) were mixed in a weight ratio of 1:2. An obtained mixture was heated to be fused to 170° C. and it was applied to the base board into a thickness of 10 μm, so that a thermosensible recording layer was obtained. Next, a polyethylene naphthalate film with a thickness of 3 μm was laminated to the thermosensible recording layer, so that a protective layer was formed.

The entire reversible thermosensible recording medium was heated at 80° C. for 10 seconds and cooled gradually, thereby obtaining a black background. Next, after the whole recording medium was cooled to room temperature and printing was executed by a reader/writer SD500-GPIII, blue characters without blur were recorded. Moreover, the entire recording medium was again heated at 80° C. for 10 seconds and cooled gradually, thereby deleting the recorded characters. However, a trace which is seemed to be caused by a contact with writer remained.

### Experimental Example 8

A transparent polyethersulphone film with a thickness of 500 μm was used as a base board. 10 parts by weight of Y—Fe₂O₃, 10 parts by weight of vinyl chloride-vinyl acetate-vinyl alcohol copolymer (made by UCC: VAGH), and 2 parts by weight of isocyanate (made by Nippon Polyurethane Industry Co., Ltd.: CORONATE L) were dispersed to a mixed solvent of 40 parts by weight of methyl ethyl ketone and 40 parts by weight of toluene. The solution was applied by a wire bar to the base board and was dried, so that a magnetic recording layer with thickness of about 10 μm was formed. A protective layer of the magnetic recording layer was formed by a urethane acrylate ultraviolet curing resin (made by Dainippon Ink and Chemicals, Inc.: UNIDIC C7-157) into a thickness of 2 μm.

Each 3 parts by weight of liquid crystal compounds represented by the chemical formulas (C1) and (D1) were mixed with 40 parts by weight of tetrahydrofuran to be fused. An obtained solution was applied by a blade to an opposite surface of the base board and was heated and dried so that a thermosensible recording layer with a thickness of 8 μm was formed as a visible information displaying section.

Next, 100 parts by weight of silicon acrylate ultraviolet curing resin (made by Toshiba Silicone Co. Ltd.: UVHC-1101), and 3 parts by weight of fluoroplastic lubricant (Asahi Glass Co., Ltd.: AFLONPOLYMIST F-5), and 2 parts by weight of ultraviolet stabilizer (Shiraisi Calucium: Seasorb 100) were dispersed to 100 parts by weight of isopropyl alcohol by ultrasonic wave. A solution was prepared in such a manner and was applied by a wire bar to the thermosensible recording layer so that its film thickness after drying becomes 3 μm. The recording layer was irradiated with ultraviolet rays to be hardened, so that a protective layer was formed.

The entire reversible thermosensible recording medium was temporarily heated to 140° C. and cooled to 80° C. and further cooled abruptly to room temperature, thereby obtaining a green background. Next, printing was executed by a reader/writer SD500-GPIII, black characters without blur were recorded. Moreover, the entire recording medium was again heated to 140° C. and cooled to 80° C. and further cooled abruptly to room temperature, thereby deleting the recorded characters. Even when recording and deletion were repeated, a trace which indicates recording history did not remain.

### Experimental Example 9

A transparent polyethylene terephthalate film with a thickness of 500 μm was used as a base board. 10 parts by weight of Y—Fe₂O₃, 10 parts by weight of vinyl chloride-vinyl acetate-vinyl alcohol copolymer (made by UCC: VAGH), and 2 parts by weight of isocyanate (made by Nippon Polyurethane Industry Co., Ltd.: CORONATE L) were dispersed to a mixed solvent of 40 parts by weight of methyl ethyl ketone and 40 parts by weight of toluene. The solution was applied by a wire bar to the base board and was dried, so that a magnetic recording layer with thickness of about 10 μm was formed. A protective layer of the magnetic recording layer was formed by a silicone acrylate ultraviolet curing resin (made by Toshiba Silicone Co. Ltd.: UVHC-1101) into a thickness of 2 am.

Each 3 parts by weigh of liquid crystal compounds represented by the chemical formulas (C1) and (D1) were mixed with 40 parts by weight of tetrahydrofuran to be fused. An obtained solution was applied by a blade to an opposite surface of the base board and was heated and dried so that a thermosensible recording layer with a thickness of 8 μm was formed as a visible information displaying section.

Next, 100 parts by weight of urethane acrylate ultraviolet curing resin (made by Dainippon Ink and Chemicals, Inc.: UNIDIC C7-157), and 6 parts by weight of barium carbonate with a particle diameter of 0.05 μm, 4 parts by weight of ultraviolet stabilizer (made by Ciba-Geigy: Tinuvin P), 0.3 part by weight of cilicone oil (Shin-Etsu Silicones: KF96) were dispersed to 100 parts by weight of isopropyl alcohol by ultrasonic wave. A solution was prepared in such a manner and was applied by a wire bar to the thermosensible recording layer so that its film thickness after drying becomes 4 μm. The recording layer was irradiated with ultraviolet rays to be hardened, so that a protective layer was formed.

The entire reversible thermosensible recording medium was temporarily heated to 140° C. and cooled to 80° C. and further cooled abruptly to room temperature, thereby obtaining a green background. Next, printing was executed by a reader/writer SD500-GPIII, black characters without blur were recorded. Moreover, the entire recording medium was again heated to 140° C. and cooled to 80° C. and further cooled abruptly to room temperature, thereby deleting the recorded characters. Even when recording and deletion were repeated, a trace which indicates recording history did not remain.

### Experimental Example 10

A black polyethylene naphthalate film with a thickness of 500 μm was used as a base board and liquid crystal compounds represented by the above chemical formulas (A1) and (B1) were mixed in a weight ratio of 1:2. An obtained mixture was heated to be fused to 170° C. and it was applied to the base board into a thickness of 10 μm, so that a thermosensible recording layer was obtained.

Next, 100 parts by weight of urethane acrylate ultraviolet curing resin (made by Dainippon Ink and Chemicals, Inc.: UNIDIC C7-157), and 5 parts by weight of silica powder with a particle diameter of 0.1 μm, and 5 parts by weight of ultraviolet stabilizer (made by Ciba-Geigy: Tinuvin 328), were dispersed by ultrasonic wave. A solution was prepared in such a manner and was applied by a wire bar to the thermosensible recording layer so that its film thickness after drying becomes 2 μm. The recording layer was irradiated with ultraviolet rays and dried at 60° C. for 24 hours to be hardened, so that a protective layer was formed.

The entire reversible thermosensible recording medium was heated at 80° C. for 10 seconds, thereby obtaining a black background. Next, after the entire recording medium was cooled to room temperature and printing was executed by a reader/writer SD500-GPIII, blue characters without blur were recorded. Moreover, the entire recording medium was again heated at 80° C. for 10 seconds, thereby deleting the recorded characters. Even when recording and deletion were repeated, a trace which indicates recording history did not remain.

(Light Resistance Test)

The recording media obtained in the embodiments 8, 9 and 10 and the comparative example 1 were irradiated with ultraviolet rays of 80 W/m² for 1000 hours by using a fadeometer tester machine (made by Suntesta: XF-180), so that their light resistance was measured.

As a result, the recording media obtained in the embodiments 8, 9 and 10 hardly changed. However, the recording medium obtained in the comparative example 1 deteriorated due to discoloration.

(Another Embodiment)

Note here that the reversible thermosensible recording medium, the information recording and displaying card and the information recording and displaying system of the present invention are not limited to the above-mentioned embodiments, and the invention can be changed variously within its gist.

Particularly, as the liquid crystal compound composing the thermosensible recording layer, various compounds can be used as long as they show cholesteric liquid crystal phase besides the ones sown by the chemical formulas (A) through (G). Moreover, the structures of the information recording and displaying card and the information recording and displaying system are arbitrary.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A reversible thermosensible recording medium comprising:
a base board;
a rewritable thermosensible recording layer which contains a liquid crystal compound showing a cholesteric liquid crystal phase and is provided on the base board; and
a protective layer which is provided on the recording layer and contains an ultraviolet curing resin and a lubricant.

2. A reversible thermosensible recording medium according to claim 1, wherein the protective layer mainly contains ultraviolet curing resin.

3. A reversible thermosensible recording medium according to claim 2, wherein the ultraviolet curing resin contains a lubricant.

4. A reversible thermosensible recording medium according to claim 3, wherein the ultraviolet curing resin contains the lubricant in a ratio of 0.1 to 50% by weight.

5. A reversible thermosensible recording medium according to claim 1, wherein the lubricant comprises fine particles.

6. A reversible thermosensible recording medium according to claim 1, wherein a co-lubricant is combined for the lubricant.

7. A reversible thermosensible recording medium according to claim 6, an adding ratio of the lubricant to the co-lubricant is 100:1 to 1:1.

8. A reversible thermosensible recording medium according to claim 1, wherein a molecular weight of the cholesteric liquid crystal compound is in a range from 1000 to 2000, and a glass transition temperature thereof is not less than 50° C.

9. A reversible thermosensible recording medium according to claim 1, wherein the thermosensible recording layer comprises a composite film of the liquid crystal compound and a high molecular resin.

10. A reversible thermosensible recording medium according to claim 1, wherein the thermosensible recording layer comprises spacers with constant shape.

11. A reversible thermosensible recording medium according to claim 1, wherein the ultraviolet curing resin comprises an acrylate resin.

12. A reversible thermosensible recording medium comprising:
a base board;
a rewritable thermosensible recording layer which contains a liquid crystal compound showing a cholesteric liquid crystal phase and is provided on the base board; and
a protective layer which is provided on the recording layer and contains an ultraviolet curing resin and an ultraviolet stabilizer.

13. A reversible thermosensible recording medium according to claim 12, wherein the protective layer mainly contains the ultraviolet curing resin.

14. A reversible thermosensible recording medium according to claim 12, wherein the ultraviolet curing resin contains the ultraviolet stabilizer.

15. A reversible thermosensible recording medium according to claim 12, wherein a molecular weight of the cholesteric liquid crystal compound is in a range from 1000 to 2000, and a glass transition temperature thereof is not less than 50° C.

16. A reversible thermosensible recording medium according to claim 12, wherein the thermosensible recording layer comprises a composite film of the liquid crystal compound and a high molecular resin.

17. A reversible thermosensible recording medium according to claim 12, wherein the thermosensible recording layer comprises spacers with constant shape.

18. A reversible thermosensible recording medium according to claim 12, wherein the ultraviolet curing resin comprises an acrylate resin.

19. A reversible thermosensible recording medium according to claim 12, wherein the protective layer contains a lubricant.

20. A reversible thermosensible recording medium according to claim 19, wherein the ultraviolet curing resin contains the lubricant in a ratio of 0.1 to 50% by weight.

21. A reversible thermosensible recording medium according to claim 19, wherein the lubricant comprises fine particles.

22. A reversible thermosensible recording medium according to claim 19, wherein a co-lubricant is combined for the lubricant.

23. A reversible thermosensible recording medium according to claim 22, an adding ratio of the lubricant to the co-lubricant is 100:1 to 1:1.

24. A reversible thermosensible recording medium according to claim 19, wherein the lubricant and the ultraviolet stabilizer are individually added to a resin component of the protective layer in the ratio of 0.1 to 30% by weight.

25. A reversible thermosensible recording medium according to claim 24, wherein a total amount of the lubricant and the ultraviolet stabilizer is a range of 1 to 40% by weight with respect to a resin component of the protective layer.

26. A reversible thermosensible recording medium according to claim 12, the ultraviolet curing resin contains the ultraviolet stabilizer in the ratio of 0.1 to 30% by weight.

27. A reversible thermosensible recording medium according to claim 12, the ultraviolet stabilizer comprises at least one of a benzotriazole derivative, a salicylic acid derivative, a 2-hyddroxybenzophenone derivative, a benzoic acid derivative, a cinnamic acid derivative, and a coumarin derivative.

28. An information recording and displaying card comprising:
a card-shaped base board;
an invisible information recording section which is provided on the base board and on which invisible information is recorded; and
a visible information displaying section which is provided on the base board and on which visible information is recorded and displayed, the visible information recording section comprising:
a rewritable thermosensible recording layer which is provided on the base board and contains a liquid crystal component showing a cholesteric liquid crystal phase; and
a protective layer which is provided on the recording layer and contains ultraviolet curing resin, and the protective layer comprising at least one of lubricant ultraviolet stabilizer.

29. An information recording and displaying system for recording and displaying information on an information recording and displaying card according to claim 28, the information recording and displaying system comprising:
a reader section for reading invisible information recorded in the invisible information recording section of the information recording and displaying card; and
a writer section for updating display contents of the visible information and displaying section of the information recording and displaying card.
